(19) United States
(12) Patent Application Publication
(10) Pub. No.: US 2010/0219734 A1
(43) Pub. Date: Sep. 2, 2010

(54) APPARATUS FOR COOLING LEDS IN A BULB

(75) Inventor: Carol Lenk, Woodstock, GA (US)

Correspondence Address: MORRISON & FOERSTER LLP, 425 MARKET STREET, SAN FRANCISCO, CA, 94105-2482, US

(73) Assignee: SuperBulbs, Inc., Redwood City, CA (US)

(21) Appl. No.: 12/663,697

(22) PCT Filed: May 29, 2008
(86) PCT No.: PCT/US08/65158

§ 371 Date: May 17, 2010

Related U.S. Application Data
(60) Provisional application No. 60/942,751, filed on Jun. 8, 2007.

(51) Int. Cl. H01J 7/26

(52) U.S. Cl. 313/35

(57) ABSTRACT

An LED bulb, which includes a shell, a heat dispersing apparatus, at least one LED attached to an upper surface of one of a plurality of fins; and a thermally conductive material within the shell of the bulb. The heat dispersing apparatus includes a plurality of fins, and a body, wherein the body separates the plurality of fins from one another.

### CROSS-REFERENCE TO RELATED APPLICATION

This application claims priority to U.S. Patent Provisional Application No. 60/942,751, filed Jun. 8, 2007, which is incorporated herein by this reference in its entirety.

### FIELD OF THE INVENTION

The present invention relates to replacement of bulbs used for lighting by light emitting diode (LED) bulbs, and more particularly, to the efficient removal of the heat generated by the LEDs in order to permit the replacement bulb to match the light output of the bulb being replaced.

### BACKGROUND OF THE INVENTION

An LED consists of a semiconductor junction, which emits light due to a current flowing through the junction. At first sight, it would seem that LEDs should make an excellent replacement for the traditional tungsten filament incandescent bulb. At equal power, they give far more light output than do incandescent bulbs, or, what is the same thing, they use much less power for equal light; and their operational life is orders of magnitude larger, namely, 10-100 thousand hours vs. 1-2 thousand hours.

However, LEDs have a number of drawbacks that have prevented them, so far, from being widely adopted as incandescent replacements. Among the chief of these is that, although LEDs require substantially less power for a given light output than do incandescent bulbs, it still takes many watts to generate adequate light for illumination. Whereas the tungsten filament in an incandescent bulb operates at a temperature of approximately 3000K, an LED, being a semiconductor, cannot be allowed to get hotter than approximately 120° C. The LED thus has a substantial heat problem: If operated in vacuum like an incandescent, or even in air, it would rapidly get too hot and fail. This has limited available LED bulbs to very low power (less than approximately 3 W), producing insufficient illumination for incandescent replacements.

More recently, a means for cooling LEDs in light bulbs has had the LEDs immersed in a fluid, a gel or a plastic (International Patent Application No. PCT/US07/10470 entitled “Heat Removal Design for LED Bulbs” and International Patent Application No. PCT/US07/10469 entitled “All-Plastic LED Bulb”). The fluid, gel or plastic provides a high thermal conductivity path from the LED heat sources to the bulb's surface and the ambient.

In some cases, however, the thermal conductivity of the fluid, gel or plastic may still not be high enough to maintain the LEDs at their desirable operating temperature given their small area of contact with the fluid, gel or plastic. This is true especially when using individual high-power LEDs as opposed to using many low-power LEDs since their power density is higher. For these applications, then, it would be desirable to find a means to even better connect the LEDs to the fluid, gel or plastic, and that at the same time maintained the desirable characteristics of the fluid, gel or plastic, that is, optical transparency or controlled optical scattering characteristics, and potentially electrical insulation.

### SUMMARY OF THE INVENTION

This invention has the object of developing a light emitting apparatus utilizing light emitting diodes (LEDs), such that the above-described primary problem is effectively solved. It aims at providing a replacement bulb for incandescent lighting having a plurality of LEDs with a light output equal in intensity to that of an incandescent bulb, and whose dissipated power may be effectively removed from the LEDs in such a way that their maximum rated temperature is not exceeded. The apparatus includes a bulb-shaped shell, preferentially formed of a plastic such as polycarbonate. The shell may be transparent, or may contain materials dispersed in it to disperse the light, making it appear not to have point sources of light, and may also contain materials dispersed in it to change the bluish color of the LED light to more yellowish color, more closely resembling the light from normal incandescent bulbs.

The shell is filled with a thermally conductive fluid, gel or plastic, such as water or a hydrogel. This fluid, gel or plastic acts as the means to transfer the heat power generated by the LEDs to the shell, where it may be removed by radiation and convection, as in a normal incandescent bulb. The fluid, gel or plastic may be transparent, or may contain materials dispersed in it to disperse the light, making it appear not to have point sources of light, and may also contain materials dispersed in it to change the bluish color of the LED light to more yellowish color, more closely resembling the light from normal incandescent bulbs. The fluid, gel or plastic is preferentially electrically insulating.

The LEDs are attached to an apparatus designed to increase the surface area of contact of the LEDs with the fluid, gel or plastic. Although similar apparatuses are often referred to as ‘heatsinks’, it can be appreciated that the apparatus is not a heatsink in the sense known to those skilled in the art because it does not function to increase the available convection cooling (although there may be some additional convection cooling in the case of the fluid). In accordance with one embodiment, the apparatus designed to increase the surface area of contact increases the effective surface area of the LED(s) and thus increase the contact area of the fluid, gel or plastic with the heat source. The fundamental reason this works is because the limited thermal conductivity of the fluid, gel or plastic results in a relatively high thermal gradient away from the LEDs. This results in inefficient usage of the fluid, gel or plastic. Enhancing the contact area of the LEDs with the fluid, gel or plastic results in greater net transfer of heat power.

In accordance with one embodiment, the apparatus designed to increase the surface area of contact may be constructed of any of various high-thermal conductivity materials such as aluminum. The apparatus designed to increase the surface area of contact may be preferentially designed with fins in order to maximize contact area with the fluid, gel or plastic. However, the fins are preferentially spaced apart in such a way that there is sufficient fluid, gel or plastic between them that there is a significant temperature drop through the material at that distance. That is, the fins cannot be arbitrarily close together because no additional contact with lower temperature fluid, gel or plastic would be achieved; the minimum distance between the fins is set by a balance between the gain of additional surface area and the loss of additional material with which to be in contact, due to the limited thermal conductivity of the surrounding fluid, gel or plastic. The particular geometry described, although optimal, is not necessary. More or fewer fins may also be used; the fins may be further apart or closer together; or there may be no fins at all. The LEDs may be mounted to the apparatus designed to increase the surface area of contact through known methods providing high thermal conductivity but electrical insulation, such as thermal epoxy.

The LEDs and the apparatus designed to increase the surface area of contact are installed in the fluid, gel or plastic in such a way as to prevent them from being shorted. If the fluid, gel or plastic is electrically insulating, no special measures need to be taken. If the fluid, gel or plastic is not electrically insulating, the electrically conductive portions of the LEDs may be electrically insulated to prevent shorting.

With the LEDs installed in the fluid, gel or plastic, the shell is sealed with a watertight seal, which is preferentially constructed of the same material as the shell. Electrical contacts for powering the LEDs are brought out through the seal before the sealing is accomplished. These leads are connected to the power source for the LEDs, which will typically be included inside the remainder of the bulb. The power source is preferentially designed to be compatible with pre-existing designs, so that the bulb may directly replace traditional bulbs without requiring any change in the pre-existing fixture.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional view of an LED bulb showing the light-emitting portion of the LED mounted in a fluid, gel or plastic.

FIG. 2 is a perspective view of an apparatus for cooling LEDs in a bulb with the LEDs mounted to the apparatus and power wires coming from the LEDs.

FIG. 3 is a cross-sectional view of an LED replacement bulb showing the apparatus for cooling LEDs in a bulb mounted inside the bulb.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

According to the design characteristics, a detailed description of the current practice and a preferred embodiment is given below.

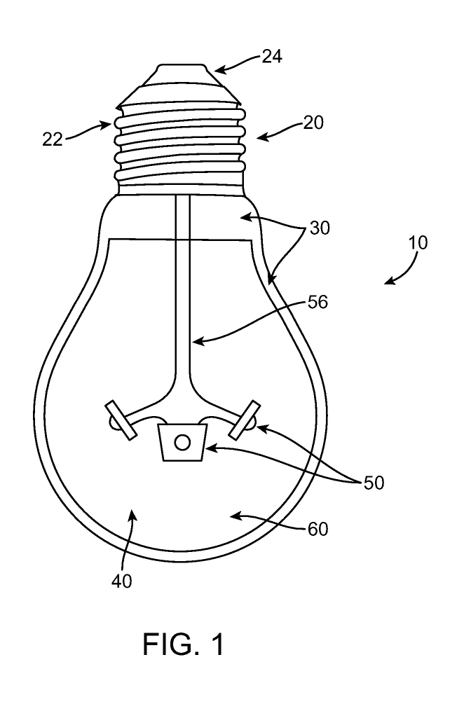

FIG. 1 is a cross-sectional view of an LED replacement bulb 10 showing LEDs mounted in a fluid, gel or plastic. As shown in FIG. 1, the LED replacement bulb includes a screw-in base 20, a shell 30, an inner portion 40 containing a fluid, plastic or gel material 60, and at least one LED 50. The screw-in base 20 includes a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the screw-in base 20 can be modified to fit within any electrical socket, which is configured to receive an incandescent bulb. The screw-in base 20 makes electrical contact with the AC power in a socket through its screw threads 20 and its base pin 24. Inside the screw-in base 20 is a power supply (not shown) that converts the AC power to a form suitable for driving the at least one LED 50.

As shown in FIG. 1, the at least one LED 50 is connected by wires 56 to the power supply. The connecting wires 56 may be stiff enough to function as support for the at least one LED 50, and may also form the interconnects between the LEDs 50 when there are multiple devices. The shell 30 also encases at least the light-emitting portion of the at least one LED 50, with the connecting wires 56 coming out through the shell 30 through a sealed connection to the power supply.

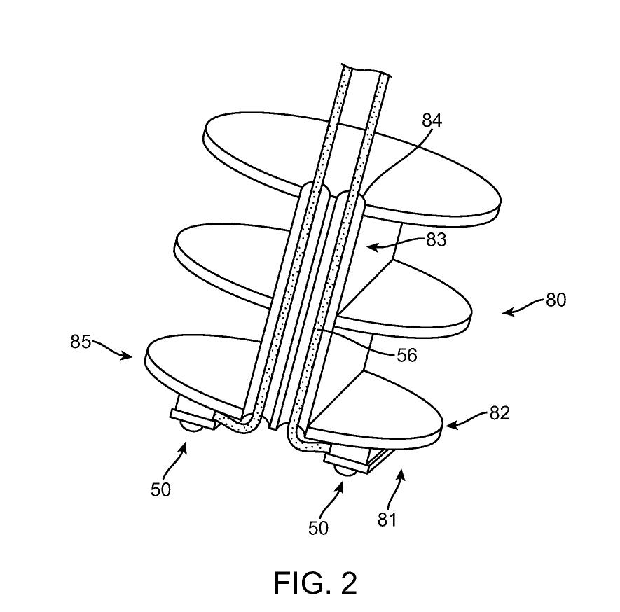

FIG. 2 is a perspective view of an apparatus 80 for cooling LEDs 50 in a bulb showing the LEDs 50 mounted to the apparatus 80 in accordance with one embodiment. The apparatus 80 may include one or more fins 82 having a relatively flat surface or top 81, and a body (or body portion) 83 having at least one slot or groove 84. The body 83 of the apparatus 80 provides separation for one or more fins 82. It can be appreciated that the body 83 of the apparatus 80 can be a hollow cylinder or other suitable hollow member. In accordance with an exemplary embodiment, the one or more fins 82 can have a circular disk-like body or other suitable shape having a large surface area. Alternatively, in accordance with another exemplary embodiment, the body 83 of the apparatus 80 can be designed without the one or more fins 82.

The body 83 also permits the one or more fins 82, if any, to have optimal contact with a surrounding fluid, gel or plastic material. In accordance with one embodiment, the apparatus 80 is preferably constructed of a high-thermal conductivity material such as aluminum. In accordance with a preferred embodiment, the at least one LED 50 is mounted to the flat surface or top 81 of the at least one fin 82. Alternatively, in accordance with another exemplary embodiment, the at least one LED 50 is mounted to the body 83.

The at least one LED 50 is preferably attached to the apparatus 80 by means of a material, which is preferably a material with high-thermal conductivity, but electrically insulating, so that the apparatus 80 is in good thermal contact with the at least one LED 50, but electrically isolated from them. The at least one groove or slot 84 allows the connecting wires 56 to run the length of the apparatus 80, without protruding out beyond the side of the apparatus 80.

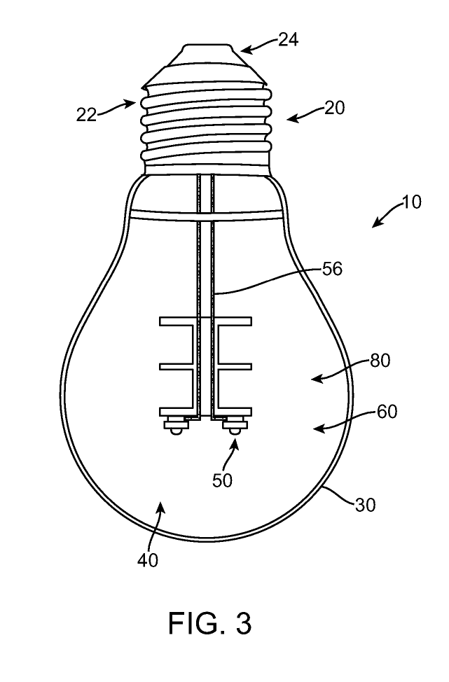

FIG. 3 is a cross-sectional view of an LED replacement bulb 10 showing the LEDs mounted in a fluid, gel or plastic according to the design of this invention. As shown in FIG. 3, the LED replacement bulb includes a base 20, a shell 30, an inner portion 40 containing a fluid, plastic or gel material 60, and at least one apparatus 80 for cooling LEDs in a bulb, and including at least one LED 50. The base 20 is preferably a screw-in base having a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the base 20 can be modified to fit within any electrical socket, which is configured to receive an incandescent bulb or other suitable bulb. The screw-in base 20 makes electrical contact with the AC power in a socket through its screw threads 20 and its base pin 24. Inside the screw-in base 20 is a power supply (not shown) that converts the AC power to a form suitable for driving the at least one LED 50.

As shown in FIG. 3, the at least one LED 50 attached to the apparatus 80 is connected by wires 56 to the power supply. The connecting wires 56 may be stiff enough to function as support for the apparatus 80 and the at least one LED 50, and can also form the interconnects between the LEDs 50 when there are multiple devices. The shell 30 encases the apparatus 80 and at least the light-emitting portion of the least one LED 50, with the connecting wires 56 coming out through the shell 30 through a sealed connection to the power supply.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A light emitting diode (LED) bulb, comprising:
a shell;
a thermally conductive gel contained within the shell of the bulb;
a heat dispersing apparatus comprising a body and at least one fin, wherein the heat dispersing apparatus projects into the thermally conductive gel contained within the shell;
at least one LED attached to the at least one fin, wherein the at least one LED is positioned within a central portion of the shell; and
a thermally conductive material disposed between the at least one LED and the at least one fin, wherein the thermally conductive material has a higher thermal conductivity than the at least one fin, and wherein one side of the thermally conductive material is in direct contact with the at least one LED and another side of the thermally conductive material is in direct contact with the at least one fin.

2. An LED bulb as set forth in claim 1, wherein the at least one fin comprises a plurality of fins, and wherein the body separates the plurality of fins from one another.

3-25. (canceled)

26. An LED bulb as set forth in claim 1, wherein said shell has a bulb shape with a neck portion, and wherein said heat-dispersing apparatus is sized to fit through the neck portion of the said bulb-shaped shell.

27. A light emitting diode (LED) incandescent bulb replacement, comprising:
an incandescent bulb-shaped shell;
a thermally conductive gel contained within the shell;
at least one fin projecting into the thermally conductive gel contained within the shell;
at least one LED attached to the at least one fin; and
a thermally conductive material disposed between the at least one LED and the at least one fin, wherein the thermally conductive material has a higher thermal conductivity than the at least one fin, and wherein one side of the thermally conductive material is in direct contact with the at least one LED and another side of the thermally conductive material is in direct contact with the at least one fin.

28-104. (canceled)

105. An LED bulb as set forth in claim 2, wherein the fins are constructed of aluminum.

106. An LED bulb as set forth in claim 2, wherein the at least one LED comprises a plurality of LEDs, and wherein each one of the plurality of LEDs is attached to each one of the plurality of fins.

107. An LED bulb as set forth in claim 106, wherein the thermally conductive material is disposed between each LED and each fin.

108. An LED bulb as set forth in claim 1, wherein the gel is mineral oil.

109. An LED bulb as set forth in claim 1, wherein the at least one fin is constructed of aluminum.

110. An LED bulb as set forth in claim 27, wherein the at least one fin comprises a plurality of fins.

111. An LED bulb as set forth in claim 110, wherein the fins of the plurality of fins are spaced apart from one another.

112. An LED bulb as set forth in claim 110, wherein the at least one LED comprises a plurality of LEDs, and wherein each one of the plurality of LEDs is attached to each one of the plurality of fins.

113. An LED bulb as set forth in claim 112, wherein the thermally conductive material is disposed between each LED and each fin.

114. An LED bulb as set forth in claim 27, wherein the gel is mineral oil.

115. An LED bulb as set forth in claim 27, wherein the at least one fin is constructed of aluminum.

116. A light emitting diode (LED) bulb, comprising:
a shell;
a thermally conductive gel contained within the shell of the bulb;
a plurality of fins projecting into the thermally conductive gel contained within the shell, wherein the fins of the plurality of fins are spaced apart from each other with gaps to allow contact with the thermally conductive gel;
a plurality of LEDs attached to the plurality of fins, wherein the plurality of LEDs are positioned within a central portion of the shell, and wherein each one of the plurality of LEDs is attached to each one of the plurality of the plurality of fins; and
a thermally conductive material disposed between each of the plurality of LEDs and each of the plurality of fins, wherein the thermally conductive material has a higher thermal conductivity than the plurality of fins, and wherein one side of the thermally conductive material is in direct contact with each of the plurality of LEDs and another side of the thermally conductive material is in direct contact with each of the plurality of fins.

117. An LED bulb as set forth in claim 116, wherein the gel is mineral oil.

118. An LED bulb as set forth in claim 116, wherein the plurality of fins is constructed of aluminum.

119. An LED bulb as set forth in claim 116, wherein said shell has a bulb shape with a neck portion, and wherein the plurality of fins is sized to fit through the neck portion of the bulb-shaped shell.

120. An LED bulb as set forth in claim 116, further comprising:
a screw-in base attached to the shell, the screw-in base having a plurality of screw threads, wherein the screw-in base is configured to make electrical contact with an AC power source.
